(19) United States
(12) Patent Application Publication
(10) Pub. No.: US 2024/0285023 A1
(43) Pub. Date: Aug. 29, 2024

(54) Waterproof Shoe And Manufacturing Method For The Waterproof Shoe

(71) Applicants: ZHONGSHAN CHANGHONG COMPOSITE MATERIAL CO., LTD., Zhongshan City (CN); FOSHAN CHENXI TEXTILE CO., LTD., Foshan City (CN)

(72) Inventors: Ke PAN, Zhongshan City (CN); Shiyong CHEN, Foshan City (CN)

(73) Assignees: ZHONGSHAN CHANGHONG COMPOSITE MATERIAL CO., LTD., Zhongshan City (CN); FOSHAN CHENXI TEXTILE CO., LTD., Foshan City (CN)

(21) Appl. No.: 18/303,469

(22) Filed: Apr. 19, 2023

(30) Foreign Application Priority Data
Feb. 27, 2023 (CN) CN202310181209.1

(51) Int. Cl. A43B 7/12

(52) U.S. Cl. CPC A43B 7/12

(57) ABSTRACT

A waterproof shoe and a manufacturing method for the waterproof shoe are disclosed. The waterproof shoe includes a waterproof shoe upper, a sealing layer and a shoe sole. A bottom portion of the waterproof shoe upper is open and is provided with a connecting member for limiting a periphery of the bottom portion of the waterproof shoe upper from extending outwardly. The connecting member connects a plurality of positions on the periphery of the bottom portion of the waterproof shoe upper. The sealing layer is injection-molded at the bottom portion of the waterproof shoe upper and penetrates into the periphery of the bottom portion of the waterproof shoe upper. The sealing layer and the waterproof shoe upper are enclosed to form a waterproof shoe cover with a sealed bottom portion.

### CROSS-REFERENCE TO RELATED APPLICATION

This application is based on and claims the benefit of priority from Chinese Patent Application No. 202310181209.1, filed on 27 Feb. 2023, the entirety of which is incorporated by reference herein.

### TECHNICAL FIELD

The disclosure relates to the technical field of shoes, and particularly to a waterproof shoe and a manufacturing method for the waterproof shoe.

### BACKGROUND

Some existing waterproof shoes usually comprise a waterproof shoe cover and a shoe sole arranged at a bottom portion of the waterproof shoe cover, wherein the waterproof shoe cover comprises a waterproof shoe upper and a mid-sole. The waterproof shoe upper usually consists of a waterproof membrane, an outer shoe upper adhered to an outer side of the waterproof membrane and an inner shoe lining adhered to an inner side of the waterproof membrane. An upper portion of the waterproof shoe upper is provided with a topline, and a bottom portion of the waterproof shoe upper is open. During manufacturing, a periphery of the bottom portion of the waterproof shoe upper is sewn to the mid-sole by wrapping, and since the periphery of the bottom portion of the waterproof shoe upper may produce a lot of wrinkles at a shoe head and a shoe heel, it is generally necessary to adhere one waterproof gasket below the mid-sole and brush glue to compact the waterproof gasket, so as to obtain the waterproof shoe cover. Finally, the shoe sole is adhered to the bottom portion of the waterproof shoe cover. For such waterproof shoe, the waterproof membrane of the waterproof shoe upper and the waterproof gasket are always separated by a layer of non-waterproof outer shoe upper, the waterproof membrane cannot be contacted with the waterproof gasket directly to form a sealed closure, and there are a lot of wrinkles between an upper foot of the waterproof shoe upper and the mid-sole, so that it is difficult to ensure that all gaps between the upper foot and the mid-sole can be blocked when brushing glue. Therefore, the bottom portion of the waterproof shoe cover has poor sealing performance, and the waterproof performance of the waterproof shoe needs to be further improved.

### SUMMARY

The disclosure aims to solve at least one of the technical problems in the existing technology. Therefore, the disclosure provides a waterproof shoe, wherein a bottom portion of a waterproof shoe cover of the waterproof shoe has better sealing performance, so that the waterproof shoe has better waterproof performance.

The disclosure further provides a manufacturing method for the waterproof shoe.

A waterproof shoe according to an embodiment in a first aspect of the disclosure comprises a waterproof shoe upper, a sealing layer and a shoe sole, a bottom portion of the waterproof shoe upper is open, the bottom portion of the waterproof shoe upper is provided with a connecting member for limiting a periphery of the bottom portion of the waterproof shoe upper from extending outwardly, and the connecting member is configured to connect a plurality of positions on the periphery of the bottom portion of the waterproof shoe upper; the sealing layer is injection-molded at the bottom portion of the waterproof shoe upper and penetrates into the periphery of the bottom portion of the waterproof shoe upper, and the sealing layer and the waterproof shoe upper are enclosed to form a waterproof shoe cover with a sealed bottom portion; and the shoe sole is located on a lower side of the sealing layer and adhered to the sealing layer.

According to some embodiments of the disclosure, the connecting member comprises a mid-sole, a periphery of the mid-sole and the periphery of the bottom portion of the waterproof shoe upper are adhered or sewn together, a part of the sealing layer fills and seals a gap between the mid-sole and the periphery of the bottom portion of the waterproof shoe upper, a part of the sealing layer is located on a lower side of the connecting member and forms a sealing bottom layer, a part of the sealing layer penetrates into the mid-sole, and a part of the sealing layer is located on an upper side of the mid-sole and forms a sealing inner layer.

According to some embodiments of the disclosure, the mid-sole is overlapped on an upper side of the periphery of the bottom portion of the waterproof shoe upper and adhered to the periphery of the bottom portion of the waterproof shoe upper, or the periphery of the mid-sole and the periphery of the bottom portion of the waterproof shoe upper are butted and sewn together.

According to some embodiments of the disclosure, the connecting member consists of a plurality of connecting lines which connect the plurality of positions on the periphery of the bottom portion of the waterproof shoe upper, and the sealing layer fills and seals a pinhole in the periphery of the bottom portion of the waterproof shoe upper and a gap in the connecting member, and wraps the connecting lines.

According to some embodiments of the disclosure, a thickness of the sealing layer is less than 15 mm.

According to some embodiments of the disclosure, a thickness of the sealing bottom layer is less than 8 mm, and a thickness of the sealing inner layer ranges from 0.5 mm to 1 mm.

According to some embodiments of the disclosure, the sealing layer is a PU layer or a rubber layer.

According to some embodiments of the disclosure, the waterproof shoe upper consists of at least one piece of composite waterproof fabric, the composite waterproof fabric comprises a waterproof layer, an outer fabric and an inner fabric, the outer fabric is adhered to an outer side surface of the waterproof layer, and the inner fabric is adhered to an inner side surface of the waterproof layer.

A manufacturing method for the waterproof shoe according to an embodiment in a second aspect of the disclosure comprises the following steps: step 1: connecting the plurality of positions on the periphery of the bottom portion of the waterproof shoe upper through the connecting member to limit the periphery of the bottom portion of the waterproof shoe upper from extending outwardly; step 2: injection-molding the sealing layer at the bottom portion of the waterproof shoe upper by an injection device, wherein a liquid glue material is capable of penetrating into the periphery of the bottom portion of the waterproof shoe upper during molding of the sealing layer; and step 3: adhering the shoe sole to the sealing bottom layer of the sealing layer.

According to some embodiments of the disclosure, in the step 2, a shoe last for supporting the waterproof shoe upper is inserted into the waterproof shoe upper, the injection device comprises an injection mold, the injection mold comprises a bottom mold and an upper mold attached to an upper side of the bottom mold, an upper surface of the bottom mold is provided with a molding groove for injecting the liquid glue material, the upper mold comprises two clamping modules rotatably connected, the two clamping modules are capable of being relatively rotated to open or close, the two clamping modules are enclosed to form a clamping hole for clamping the bottom portion of the waterproof shoe upper, the clamping hole is arranged opposite to the molding groove, a positioning plate for mutually matching and abutting with the shoe last is arranged above one of the clamping modules, and the other one of the clamping modules is rotatably connected with the bottom mold, wherein a horizontal side of the bottom mold is provided with a loading and unloading station for loading and unloading the waterproof shoe upper, and the upper mold is capable of being rotated to the loading and unloading station.

The waterproof shoe and the manufacturing method for the waterproof shoe according to the embodiments of the disclosure have at least the following beneficial effects. By the manufacturing method above, the sealing layer can be injection-molded at the bottom portion of the waterproof shoe upper. During molding of the sealing layer, the liquid glue material can penetrate into the periphery of the bottom portion of the waterproof shoe upper and fill the gap between the connecting member and the periphery of the bottom portion of the waterproof shoe upper under a pressure. After the liquid glue material is cooled to form the sealing layer, even if there are a lot of wrinkles at the periphery of the bottom portion of the waterproof shoe upper, the sealing layer can also effectively fill and block the gap between the connecting member and the periphery of the bottom portion of the waterproof shoe upper, the sealing layer can completely seal the bottom portion of the waterproof shoe upper. Then the sealing layer and the waterproof shoe upper are enclosed to form the waterproof shoe cover with better bottom sealing performance, so that the waterproof shoe provided by the disclosure has better waterproof performance, and a waterproof gasket can be omitted. The sealing layer can also improve a strength of the bottom portion of the waterproof shoe cover, so that the waterproof shoe is more durable.

Additional aspects and advantages of the disclosure will be given in part in the following description, which will become apparent from the following description or be understood through practice of the disclosure.

### BRIEF DESCRIPTION OF THE DRAWINGS

The above and/or additional aspects and advantages of the disclosure will become apparent and easy to understand from the descriptions of embodiments with reference to the following drawings, wherein:

FIG. 1 is a partial sectional view of a waterproof shoe according to an embodiment of the disclosure (when a periphery of a mid-sole and a periphery of a bottom portion of a waterproof shoe upper are adhered);

FIG. 2 is an enlarged view of a part A in FIG. 1;

FIG. 3 is a partial sectional view of the waterproof shoe according to the embodiment of the disclosure (when the periphery of the mid-sole and the periphery of the bottom portion of the waterproof shoe upper are sewn);

FIG. 4 is an enlarged view of a part B in FIG. 3;

FIG. 5 is a partial sectional view of the waterproof shoe according to the embodiment of the disclosure (when a connecting member consists of a plurality of connecting lines);

FIG. 6 is an enlarged view of a part C in FIG. 5;

FIG. 7 is a schematic diagram of the periphery of the bottom portion of the waterproof shoe upper of the waterproof shoe in FIG. 5 connected through the connecting lines;

FIG. 8 is a schematic diagram of an injection mold used in a manufacturing method for the waterproof shoe according to an embodiment of the disclosure;

FIG. 9 is a schematic diagram of the injection mold shown in FIG. 8; and

FIG. 10 is an enlarged view of a part D in FIG. 8.

### REFERENCE NUMERALS

110 refers to waterproof shoe upper, 111 refers to waterproof layer, 112 refers to outer fabric, 113 refers to inner fabric, 120 refers to mid-sole, 130 refers to connecting line, 200 refers to sealing layer, 210 refers to sealing bottom layer, 220 refers to sealing inner layer, 300 refers to shoe sole, 400 refers to injection mold, 410 refers to bottom mold, 411 refers to molding groove, 420 refers to upper mold, 421 refers to clamping module, 422 refers to positioning plate, 423 refers to clamping hole, 430 refers to first locking apparatus, 431 refers to first lock catch, 432 refers to first shaft lever, 433 refers to first operating handle, 440 refers to second locking apparatus, 441 refers to second lock catch, 442 refers to second shaft lever, and 443 refers to second operating handle.

### DETAILED DESCRIPTION

Embodiments of the disclosure are described in detail hereinafter, examples of the embodiments are shown in the drawings, and the same or similar reference numerals throughout the drawings denote the same or similar elements or elements having the same or similar functions. The embodiments described hereinafter with reference to the drawings are exemplary, are only intended to explain the disclosure, and cannot be understood as limiting the disclosure.

In the description of the disclosure, it should be understood that, the orientation or position relationship related to the orientation description, such as the orientation or position relationship indicated by the terms “upper”, “lower”, “front”, “rear”, “left”, “right”, and the like is based on the orientation or position relationship shown in the drawings, which is only used for convenience of the description of the disclosure and simplification of the description instead of indicating or implying that the indicated device or element must have a specific orientation, and be constructed and operated in a specific orientation, and thus should not be understood as a limitation to the disclosure.

In the description of the disclosure, the meaning of several refers to being one or more, and the meaning of multiple refers to being two or more. The meanings of greater than, less than, more than, etc., are understood as not including this number, while the meanings of above, below, within, etc., are understood as including this number. If there is the description of first and second, it is only for the purpose of distinguishing between technical features, and should not be understood as indicating or implying relative importance, implicitly indicating the number of the indicated technical features or implicitly indicating the order of the indicated technical features.

In the description of the disclosure, unless otherwise explicitly defined, the terms “setting”, “mounting” and “connecting” should be understood in a broad sense, and those of ordinary skills in the art can reasonably determine the specific meanings of the above terms in the disclosure in combination with the specific contents of the technical solution.

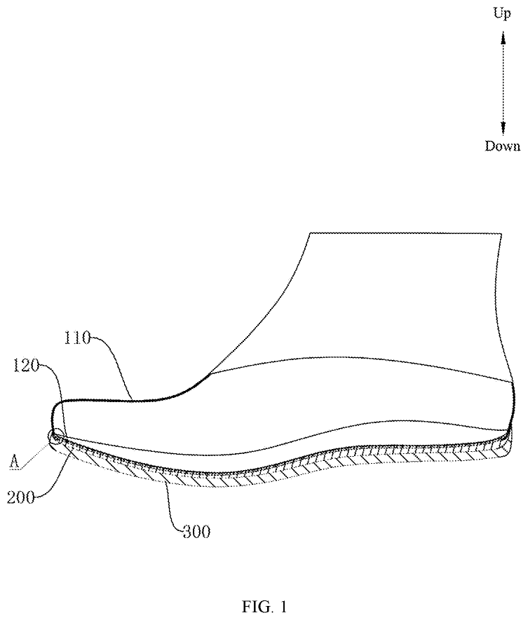

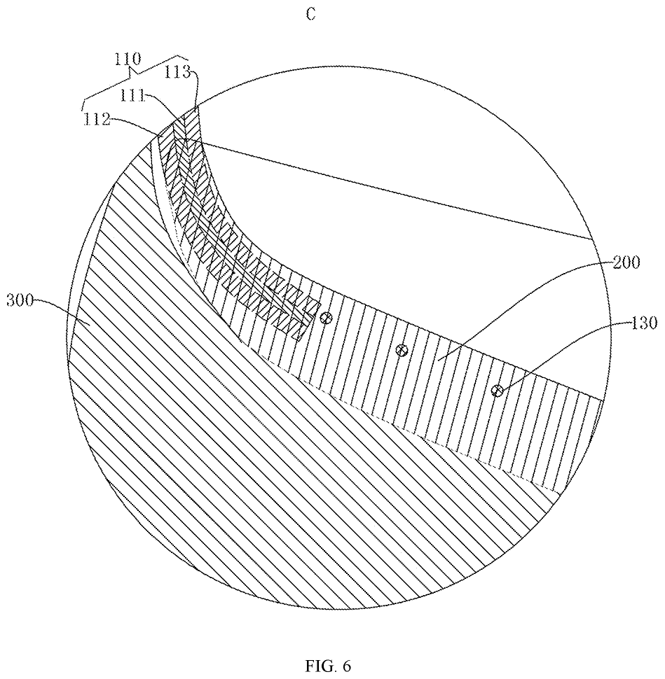

With reference to FIG. 1 to FIG. 6, a waterproof shoe provided by an embodiment of the disclosure comprises a waterproof shoe upper 110, a sealing layer 200 and a shoe sole 300. A bottom portion of the waterproof shoe upper 110 is open, the bottom portion of the waterproof shoe upper 110 is provided with a connecting member for limiting a periphery of the bottom portion of the waterproof shoe upper 110 from extending outwardly, and the connecting member connects a plurality of positions on the periphery of the bottom portion of the waterproof shoe upper 110, thus avoiding the bottom portion of the waterproof shoe upper 110 from spreading outwardly. The sealing layer 200 is injection-molded at the bottom portion of the waterproof shoe upper 110 and penetrates into the periphery of the bottom portion of the waterproof shoe upper 110, and the sealing layer 200 and the waterproof shoe upper 110 are enclosed to form a waterproof shoe cover with a sealed bottom portion. The shoe sole 300 is located on a lower side of the sealing layer 200 and adhered to the sealing layer 200.

An embodiment of the disclosure further provides a manufacturing method for the waterproof shoe above. The manufacturing method comprises the following steps: step 1: connecting the plurality of positions on the periphery of the bottom portion of the waterproof shoe upper 110 through the connecting member to limit the periphery of the bottom portion of the waterproof shoe upper 110 from extending outwardly; step 2: injection-molding the sealing layer 200 at the bottom portion of the waterproof shoe upper 110 by an injection device, wherein a liquid glue material is capable of penetrating into the periphery of the bottom portion of the waterproof shoe upper 110 during molding of the sealing layer 200; and step 3: adhering the shoe sole 300 to the sealing bottom layer 210 of the sealing layer 200.

By the manufacturing method above, the sealing layer 200 may be injection-molded at the bottom portion of the waterproof shoe upper 110. During molding of the sealing layer 200, the liquid glue material may penetrate into the periphery of the bottom portion of the waterproof shoe upper 110 and fill the gap between the connecting member and the periphery of the bottom portion of the waterproof shoe upper 110 under a pressure. After the liquid glue material is cooled to form the sealing layer 200, even if there are a lot of wrinkles at the periphery of the bottom portion of the waterproof shoe upper 110, the sealing layer 200 can also effectively fill and block the gap between the connecting member and the periphery of the bottom portion of the waterproof shoe upper 110, the sealing layer 200 can completely seal the bottom portion of the waterproof shoe upper 110. Then the sealing layer 200 and the waterproof shoe upper 110 are enclosed to form the waterproof shoe cover with better bottom sealing performance, so that the waterproof shoe provided by the disclosure has better waterproof performance, and a waterproof gasket can be omitted. The sealing layer 200 can also improve a connection strength of the bottom portion of the waterproof shoe cover, so that the waterproof shoe is more durable. In addition, a lower surface of the sealing layer 200 above is relatively smooth and flat, so that the sealing layer can be adhered to the shoe sole 300 more conveniently.

In the disclosure, a setting method of combining the injection-molded sealing layer 200 with the adhered shoe sole 300 is used in the waterproof shoe, manufacturers may adhere the shoe soles 300 made of different materials for different uses to the sealing layer 200 as required, and the adhered shoe sole 300 has more choices in shape and appearance. In addition, the adhered shoe sole 300 has been designed with various protrusions, patterns or other anti-skid structures, so that it is unnecessary to arrange the anti-skid structures with high precision requirements and high injection-molding difficulty on a lower surface of the sealing layer 200. The sealing layer 200 is simple in appearance and low in precision requirements, the sealing layer 200 is easy to be injection-molded, and a mold used for injection-molding the sealing layer 200 is also simple, thus ensuring that the sealing layer 200 has a low processing cost and a high qualified rate. Therefore, the waterproof shoe provided by the disclosure has better waterproof performance and can also ensure the cost advantage, thus being beneficial for improving the market competitiveness.

It should be noted that the flatness and smoothness of the lower surface of the sealing layer 200 are described relatively to a lower surface of the shoe sole 300, and the flat and smooth lower surface of the sealing layer 200 refers to that the lower surface of the sealing layer 200 has no obvious structures, such as protrusions and patterns.

Some traditional waterproof shoes comprise a non-waterproof shoe cover and a waterproof inner liner placed in the shoe cover, a gap exists between the waterproof inner liner and the shoe cover of such waterproof shoe, and external water is easy to enter and stay between the waterproof inner liner and the shoe cover, resulting in a heavy shoe and easy frostbite of foot of a user in cold weather. For the waterproof shoe provided by the present application, the waterproof shoe cover has good waterproof performance, and it is unnecessary to arrange the waterproof inner liner in the waterproof shoe cover, so that the problems of the heavy shoe and the frostbite of foot caused by external water entering the waterproof shoe can be effectively avoided.

For a waterproof shoe in the existing technology, a thickness between a bottom surface of the shoe sole 300 and an upper side surface of the mid-sole 120 at waist and heel positions of the waterproof shoe is usually required to be greater than 30 mm. In the present application, a thickness of the sealing layer 200 is less than 15 mm, and manufacturers may adhere the shoe sole 300 to a lower side of the sealing layer 200, so that a thickness between the bottom surface of the shoe sole 300 and an upper side surface of the connecting member at waist and heel positions of the waterproof shoe can meet use requirements.

In some embodiments, after finishing the step 2, a sealing performance test may be performed on the waterproof shoe cover. Due to the arrangement of the sealing layer 200, the bottom portion of the waterproof shoe cover is well sealed, and generally, only the waterproof shoe upper 110 will possibly be poor in sealing. It is conceivable that when the waterproof shoe cover becomes a waste product due to poor sealing of the waterproof shoe upper 110, material waste can be reduced due to the thin thickness of the sealing layer 200.

With reference to FIG. 1 to FIG. 4, it is conceivable that, in some embodiments, the connecting member comprises a mid-sole 120, and a periphery of the mid-sole 120 and the periphery of the bottom portion of the waterproof shoe upper 110 are adhered or sewn together, wherein a part of the sealing layer 200 above fills and seals a gap between the mid-sole 120 and the periphery of the bottom portion of the waterproof shoe upper 110, a part of the sealing layer 200 is located on a lower side of the connecting member and forms a sealing bottom layer 210, a part of the sealing layer 200 is located on an upper side of the mid-sole 120 and forms a sealing inner layer 220. Due to existence of pores in the mid-sole 120, and a part of the sealing layer 200 may penetrate into the mid-sole 120. In this way, the sealing layer 200 can wrap the mid-sole 120 and the periphery of the bottom portion of the waterproof shoe upper 110, and even if there are a lot of wrinkles on the periphery of the bottom portion of the waterproof shoe upper 110, the sealing layer 200 can also effectively fill and seal a gap and/or a pinhole between the mid-sole 120 and the periphery of the bottom portion of the waterproof shoe upper 110, thus forming the waterproof shoe cover with better bottom sealing performance. In the present application, the bottom portion of the waterproof shoe upper 110 may be connected by the mid-sole 120. Since the sealing layer 200 can improve a connection strength between the mid-sole 120 and the periphery of the bottom portion of the waterproof shoe upper 110, the mid-sole 120 and the periphery of the bottom portion of the waterproof shoe upper 110 may be connected by a traditional sewing method or an adhesive method, wherein the adhesive method is simpler and more convenient than the sewing method, which is beneficial for improving production efficiency.

Specifically, when the connecting member above is set as the mid-sole 120, a thickness of the sealing bottom layer 210 is less than 8 mm, and a thickness of the sealing inner layer 220 ranges from 0.5 mm to 1 mm, while a thickness of the periphery of the bottom portion of the waterproof shoe upper 110 is usually less than 2 mm, and a thickness of the mid-sole 120 is usually less than 2 mm, so that the thickness of the entire sealing layer 200 may be controlled within 11 mm. Therefore, the sealing layer 200 is relatively thin.

It is conceivable that the thickness of the sealing bottom layer 210 close to a head portion of the waterproof shoe cover ranges from 1.5 mm to 2.5 mm, the thickness of the sealing bottom layer 210 close to a waist portion of the waterproof shoe cover ranges from 3 mm to 4 mm, and the thickness of the sealing bottom layer 210 close to a heel portion of the waterproof shoe cover ranges from 2.5 mm to 3.5 mm. By the above arrangement, the sealing layer 200 can adapt to a foot shape of a consumer, thus bringing more comfortable experience to the consumer.

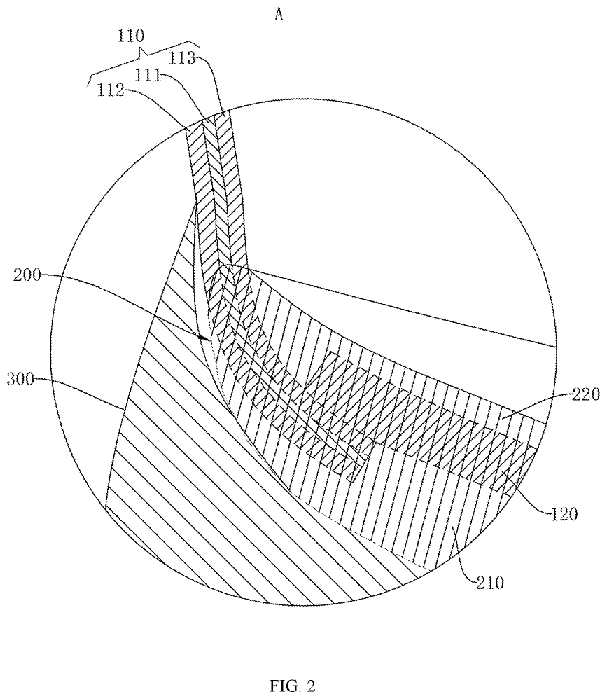

With reference to FIG. 1 and FIG. 2, in some embodiments, when the mid-sole 120 is connected with the periphery of the bottom portion of the waterproof shoe upper 110 by the adhesive method, the mid-sole 120 is overlapped on an upper side of the periphery of the bottom portion of the waterproof shoe upper 110 and adhered to the periphery of the bottom portion of the waterproof shoe upper 110. In the step 1, glue may be conveniently coated on the periphery of the mid-sole 120, and then the periphery of the bottom portion of the waterproof shoe upper 110 may be conveniently folded and overlapped on the mid-sole 120, so that the mid-sole 120 and the periphery of the bottom portion of the waterproof shoe upper 110 are adhered, realizing a relatively simple adhering process.

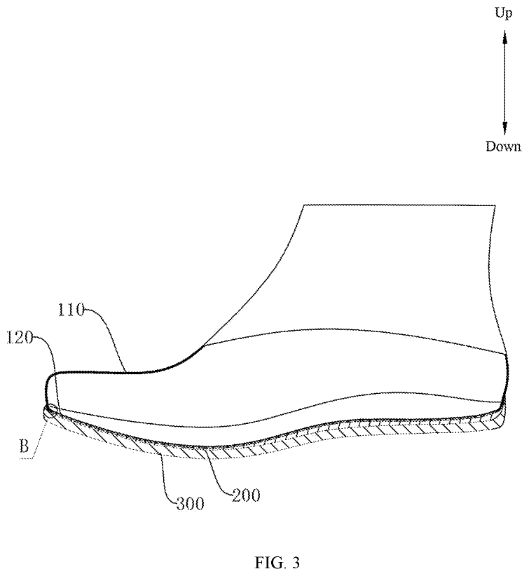

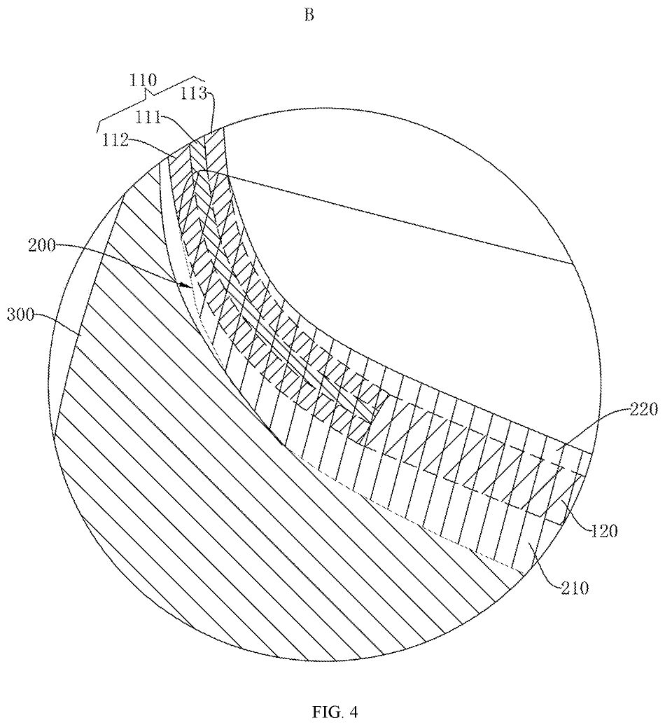

With reference to FIG. 3 and FIG. 4, in some embodiments, when the mid-sole 120 is connected with the periphery of the bottom portion of the waterproof shoe upper 110 by the sewing method, the periphery of the mid-sole 120 and the periphery of the bottom portion of the waterproof shoe upper 110 are butted and sewn together, so that the total thickness of the sealing layer 200 is thinner, thus reducing the cost.

It should be noted that, in other embodiments, the mid-sole 120 may also be located on a lower side of the periphery of the bottom portion of the waterproof shoe upper 110, and sewn with or adhered to the periphery of the bottom portion of the waterproof shoe upper 110.

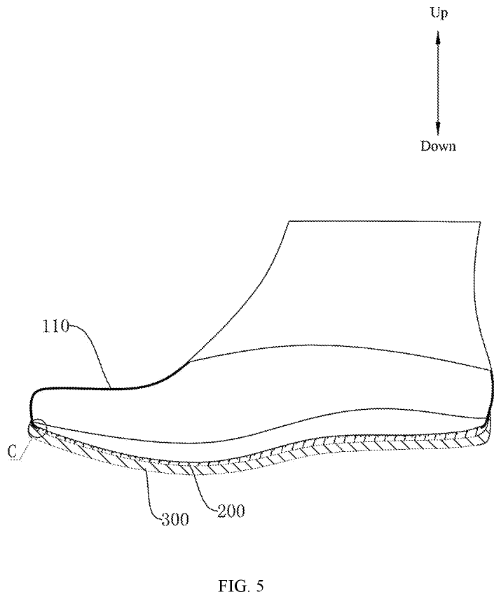

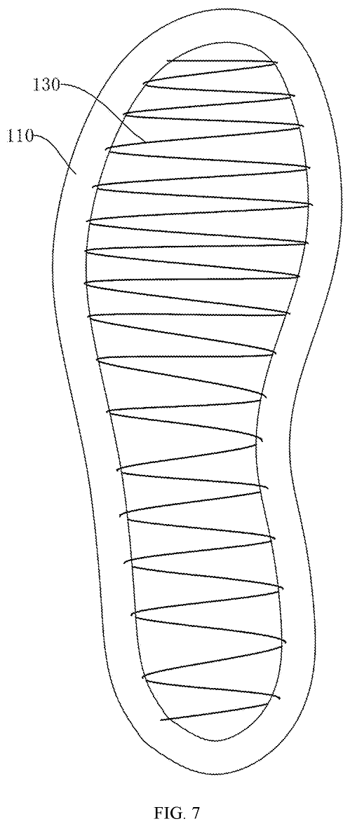

With reference to FIG. 5 to FIG. 7, it is conceivable that, in some embodiments, the connecting member consists of a plurality of connecting lines 130 which connect the plurality of positions on the periphery of the bottom portion of the waterproof shoe upper 110, and the sealing layer 200 may fill and seal a pinhole in the periphery of the bottom portion of the waterproof shoe upper 110 and a gap in the connecting member, and wrap the connecting lines 130, thus forming the waterproof shoe cover with better bottom sealing performance. Compared with the mid-sole 120, the connecting member consisting of the connecting lines 130 above has a wider gap, and during injection-molding of the sealing layer 200, the liquid glue material is easier to penetrate into and fill the gap on the connecting member, and the liquid glue material is easier to wrap the connecting lines 130, thus being convenient for molding of the sealing layer 200. In addition, compared with the mid-sole 120, the connecting lines 130 have less influence on flexibility, air permeability or other performances of the sealing layer 200, and the sealing layer 200 has sufficient flexibility, so that the waterproof shoe provided by the present application may be used without adding an insole, and sufficient comfort of the waterproof shoe can also be ensured. In this way, a process of adding the insole can be omitted in use of the waterproof shoe, and the problem of losing the insole can be avoided, thus being convenient to use and reducing the cost.

It is conceivable that, in a specific implementation process, the sealing layer 200 may also be a PU layer, a rubber layer or other plastic layers.

With reference to FIG. 2 and FIG. 4, in some embodiments, it is conceivable that the waterproof shoe upper 110 consists of at least one piece of composite waterproof fabric, the composite waterproof fabric comprises a waterproof layer 111, an outer fabric 112 and an inner fabric 113, the outer fabric 112 is adhered to an outer side surface of the waterproof layer 111, and the inner fabric 113 is adhered to an inner side surface of the waterproof layer 111. By the above arrangement, the composite waterproof fabric has good waterproof performance.

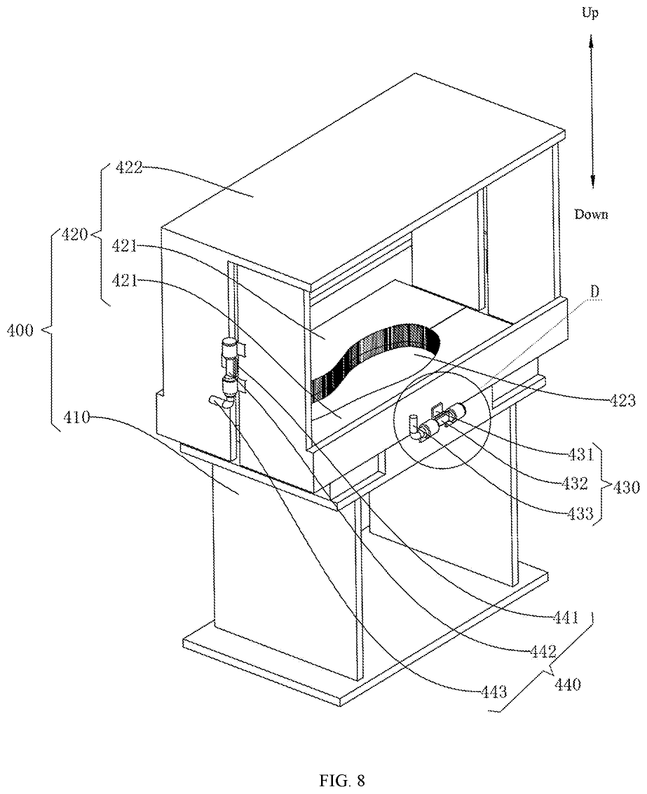

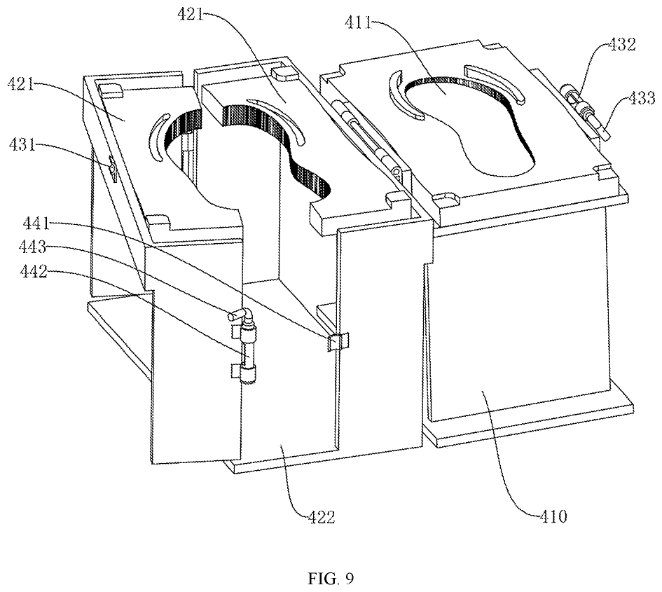

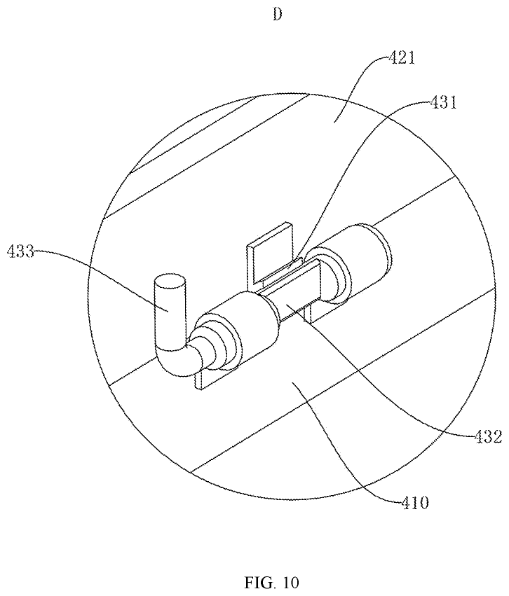

With reference to FIG. 8 to FIG. 10, in some embodiments, it is conceivable that, in the step 2, a shoe last for supporting the waterproof shoe upper 110 is inserted into the waterproof shoe upper 110. The injection device comprises an injection mold 400, the injection mold 400 comprises a bottom mold 410 and an upper mold 420 attached to an upper side of the bottom mold 410, an upper surface of the bottom mold 410 is provided with a molding groove 411 for injecting the liquid glue material. The upper mold 420 comprises two clamping modules 421 rotatably connected, the two clamping modules 421 are capable of being relatively rotated to open or close, the two clamping modules 421 are enclosed to form a clamping hole 423 for clamping the bottom portion of the waterproof shoe upper 110, the clamping hole 423 is arranged opposite to the molding groove 411. A positioning plate 422 for mutually matching and abutting with the shoe last is arranged above one clamping module 421, and the other clamping module 421 is rotatably connected with the bottom mold 410, wherein a horizontal side of the bottom mold 410 is provided with a loading and unloading station for loading and unloading the waterproof shoe upper 110, the upper mold 420 is capable of being rotated to the loading and unloading station, and the upper mold 420 can load and unload the waterproof shoe upper 110 more conveniently at the loading and unloading station. By the above arrangement, the two clamping modules 421 can match with each other to clamp the waterproof shoe upper 110, and the waterproof shoe upper 110 can be positioned through matching between the positioning plate 422 and the shoe last, thus ensuring that the sealing layer 200 can be smoothly molded with high molding accuracy.

It should be noted that the shoe last may be inserted into the waterproof shoe upper 110 in the step 1 to assist the connecting member to connect the periphery of the bottom portion of the waterproof shoe upper 110. Certainly, the shoe last may also be inserted into the waterproof shoe upper 110 in the step 2. Since the connecting member can limit the periphery of the bottom portion of the waterproof shoe upper 110 from extending outwardly, and mutual matching between the connecting member and the shoe last can keep the waterproof shoe upper 110 in a certain shape, thus ensuring that the sealing layer 200 can be smoothly injection-molded.

In the step 2, the upper mold 420 is rotated to the loading and unloading station first, the two clamping modules 421 are rotated to open, then the bottom portion of the waterproof shoe upper 110 is upwardly placed between the two clamping modules 421 and the shoe last is abutted against the positioning plate 422, and then the two clamping modules 421 are relatively rotated to close and clamp the bottom portion of the waterproof shoe upper 110. At the moment, the bottom portion of the waterproof shoe upper 110 is clamped in the clamping hole 423, then the upper mold 420 is rotated to be located above the bottom mole 410 and attached to the bottom mold 410, and finally, the injection device injects the liquid glue material into the molding groove 411.

With reference to FIG. 8 to FIG. 10, a first locking apparatus 430 is arranged between the upper mold 420 and the bottom mold 410, and when the upper mold 420 is located on an upper side of the bottom mold 410, the first locking apparatus 430 locks the upper mold 420 to the bottom mold 410. A second locking apparatus 440 is arranged between the two clamping modules 421, and the second locking apparatus 440 is used to make the two clamping modules 421 clamp the bottom portion of the waterproof shoe upper 110. By the above arrangement, the upper mold 420 can be locked to the bottom mold 410 and the two clamping modules 421 can clamp the bottom portion of the waterproof shoe upper 110, thus ensuring smooth molding of the sealing layer 200.

With reference to FIG. 8 to FIG. 10, specifically, the first locking apparatus 430 comprises a first lock catch 431 and a first shaft lever 432. The first lock catch 431 is arc-shaped, the first lock catch 431 is fixed on the corresponding clamping module 421, and the first shaft lever 432 is rotatably mounted on the bottom mold 410. A middle portion of the first shaft lever 432 is semicircular, and one end of the first shaft lever 432 is provided with a first operating handle 433 along a radial direction. By rotating the first shaft lever 432 through the first operating handle 433, the middle portion of the first shaft lever 432 can be rotated to enter the first lock catch 431 and clamp with the first lock catch 431, thus locking the upper mold 420 to the bottom mold 410. By rotating the first shaft lever 432 through the first operating handle 433, the middle portion of the first shaft lever 432 can be separated from the first lock catch 431, thus unlocking the upper mold 420. The first shaft lever 432 is rotated through the first operating handle 433, which is convenient to operate and more labor-saving.

With reference to FIG. 8 to FIG. 10, specifically, the second locking apparatus 440 comprises a second lock catch 441 and a second shaft lever 442. The second lock catch 441 is arc-shaped, the second lock catch 441 is fixed on one of the clamping modules 421, and the second shaft lever 442 is rotatably mounted on the other one of the clamping modules 421. A middle portion of the second shaft lever 442 is semicircular, and one end of the second shaft lever 442 is provided with a second operating handle 443 along a radial direction. By rotating the second shaft lever 442 through the second operating handle 443, the middle portion of the second shaft lever 442 can be rotated to enter the second lock catch 441 and clamp with the second lock catch 441, thus making the two clamping modules 421 clamp the bottom portion of the waterproof shoe upper 110. By rotating the second shaft lever 442 through the second operating handle 443, the second shaft lever 442 can be rotated to be separated from the second lock catch 441, so that the two clamping modules 421 can be relatively rotated to open. The second shaft lever 442 is rotated through the second operating handle 443, which is convenient to operate and more labor-saving.

Various technical features of the above embodiments may be combined arbitrarily, and in order to simplify the description, possible combinations of various technical features in the above embodiments are not all described. However, as long as the combinations of these technical features have no contradiction, the combinations of these technical features should be considered as falling into the scope recorded by the specification.

The embodiments of the disclosure are described in detail with reference to the drawings above, but the disclosure is not limited to the above embodiments, and various changes may also be made within the knowledge scope of those of ordinary skills in the art without departing from the purpose of the disclosure.

1. A waterproof shoe, comprising:
a waterproof shoe upper, wherein a bottom portion of the waterproof shoe upper is open, the bottom portion of the waterproof shoe upper is provided with a connecting member for limiting a periphery of the bottom portion of the waterproof shoe upper from extending outwardly, and the connecting member is configured to connect a plurality of positions on the periphery of the bottom portion of the waterproof shoe upper;
a sealing layer, wherein the sealing layer is injection-molded at the bottom portion of the waterproof shoe upper and penetrates into the periphery of the bottom portion of the waterproof shoe upper, and the sealing layer and the waterproof shoe upper are enclosed to form a waterproof shoe cover with a sealed bottom portion; and
a shoe sole located on a lower side of the sealing layer and adhered to the sealing layer.

2. The waterproof shoe according to claim 1, wherein the connecting member comprises a mid-sole, a periphery of the mid-sole and the periphery of the bottom portion of the waterproof shoe upper are adhered or sewn together, a part of the sealing layer fills and seals a gap between the mid-sole and the periphery of the bottom portion of the waterproof shoe upper, a part of the sealing layer is located on a lower side of the connecting member and forms a sealing bottom layer, a part of the sealing layer penetrates into the mid-sole, and a part of the sealing layer is located on an upper side of the mid-sole and forms a sealing inner layer.

3. The waterproof shoe according to claim 2, wherein the mid-sole is overlapped on an upper side of the periphery of the bottom portion of the waterproof shoe upper and adhered to the periphery of the bottom portion of the waterproof shoe upper, or the periphery of the mid-sole is butted and sewn with the periphery of the bottom portion of the waterproof shoe upper.

4. The waterproof shoe according to claim 1, wherein the connecting member consists of a plurality of connecting lines which connect the plurality of positions on the periphery of the bottom portion of the waterproof shoe upper, and the sealing layer fills and seals a pinhole in the periphery of the bottom portion of the waterproof shoe upper and a gap in the connecting member, and wraps the connecting lines.

5. The waterproof shoe according to claim 1, wherein a thickness of the sealing layer is less than 15 mm.

6. The waterproof shoe according to claim 2, wherein a thickness of the sealing bottom layer is less than 8 mm, and a thickness of the sealing inner layer ranges from 0.5 mm to 1 mm.

7. The waterproof shoe according to claim 1, wherein the sealing layer is a PU layer or a rubber layer.

8. The waterproof shoe according to claim 1, wherein the waterproof shoe upper consists of at least one piece of composite waterproof fabric, the composite waterproof fabric comprises a waterproof layer, an outer fabric and an inner fabric, the outer fabric is adhered to an outer side surface of the waterproof layer, and the inner fabric is adhered to an inner side surface of the waterproof layer.

9. A manufacturing method for the waterproof shoe according to claim 1, comprising:
step 1: connecting the plurality of positions on the periphery of the bottom portion of the waterproof shoe upper through the connecting member to limit the periphery of the bottom portion of the waterproof shoe upper from extending outwardly;
step 2: injection-molding the sealing layer at the bottom portion of the waterproof shoe upper by an injection device, wherein a liquid glue material is capable of penetrating into the periphery of the bottom portion of the waterproof shoe upper during molding of the sealing layer; and
step 3: adhering the shoe sole to the sealing bottom layer of the sealing layer.

10. The manufacturing method for the waterproof shoe according to claim 9, wherein in the step 2, a shoe last for supporting the waterproof shoe upper is inserted into the waterproof shoe upper, the injection device comprises an injection mold, the injection mold comprises a bottom mold and an upper mold attached to an upper side of the bottom mold, an upper surface of the bottom mold is provided with a molding groove for injecting the liquid glue material, the upper mold comprises two clamping modules rotatably connected, the two clamping modules are capable of being relatively rotated to open or close, the two clamping modules are enclosed to form a clamping hole for clamping the bottom portion of the waterproof shoe upper, the clamping hole is arranged opposite to the molding groove, a positioning plate for mutually matching and abutting with the shoe last is arranged above one of the clamping modules, and the other one of the clamping modules is rotatably connected with the bottom mold, wherein a horizontal side of the bottom mold is provided with a loading and unloading station for loading and unloading the waterproof shoe upper, and the upper mold is capable of being rotated to the loading and unloading station.
